(19) United States
(12) Patent Application Publication
(10) Pub. No.: US 2026/0367653 A1
(43) Pub. Date: Nov. 19, 2026

(54) DUAL FLOAT LIQUID LEVEL CONTROL SYSTEM

(71) Applicant: Daniel Eich, Canyon Lake, TX (US)

(72) Inventor: Daniel Eich, Canyon Lake, TX (US)

(21) Appl. No.: 19/674,913

(22) Filed: May 12, 2026

Related U.S. Application Data
(60) Provisional application No. 63/804,757, filed on May 13, 2025.

(51) Int. Cl. G05D 9/12; F16K 31/32; F16K 33/00; G08B 7/06; G08B 21/18

(52) U.S. Cl. CPC G05D 9/12; F16K 31/32; F16K 33/00; G08B 7/06; G08B 21/182; G08B 21/187

(57) ABSTRACT

The system is configured to regulate liquid levels within a holding tank through operation of a first float switch and a second float switch electrically coupled to a control box. The first float switch may define a lower activation threshold, while the second float switch may define an upper deactivation threshold to maintain a controlled liquid range. The control box may comprise manual and automatic switches, indicator lights, transformers, and low-voltage power supplies. The float switches may further comprise cable glands and weighted members for stable positioning. One or more contactors may be coupled to pumps or circulation devices to reduce electrical cycling and contactor vibration. The system may further comprise a splash-proof housing and a supplemental control box having warning indicators, alarms, and timer controls configured to detect fluid loss or pump failure conditions and improve operational reliability and equipment longevity.

### CROSS-REFERENCE TO RELATED APPLICATION

The present application claims priority to, and the benefit of, U.S. Provisional Application No. 63/804,757, which was filed on May 13, 2025, and is incorporated herein by reference in its entirety.

### FIELD OF THE INVENTION

The present invention relates generally to the field of fluid level control systems. More specifically, the present invention relates to a system that is configured to maintain liquid within a controlled upper and lower range inside a holding tank through coordinated operation of multiple float switches. Accordingly, the present disclosure makes specific reference thereto. Nonetheless, it is to be appreciated that aspects of the present invention are also equally applicable to other like applications, devices, and methods of manufacture.

### BACKGROUND

Fluid management systems are commonly used in industrial, agricultural, and commercial applications to maintain liquid levels within holding tanks and reservoirs. Many conventional systems rely upon a single float switch to control activation and deactivation of pumps or refill mechanisms. Single-float arrangements may lead to frequent electrical cycling due to rapid fluctuations in liquid levels during operation. Repeated cycling may increase wear on pumps, contactors, relays, and associated electrical components, thereby reducing operational lifespan. Improper calibration or float failure may further result in overflow conditions or dry-running conditions that can damage connected equipment and interrupt process operations. In many liquid storage environments, stagnant fluid conditions may also occur when no circulation or agitation mechanism is present within the tank. Lack of agitation may contribute to sediment accumulation, fluid separation, or bacterial growth that negatively impacts fluid quality and system performance. Conventional float systems may additionally experience unstable switch contact conditions that create electrical issues such as switch bounce, contactor chatter, or over-amperage events. Such conditions may increase maintenance requirements and reduce operational reliability.

Therefore, there exists a long-felt need in the art for a system that maintains liquid within a precise upper and lower operating range. There also exists a long-felt need in the art for a dual float liquid control system that separates activation and deactivation functions to provide greater operational control than single-float systems. Moreover, there exists a long-felt need in the art for a dual float liquid control system that reduces electrical load, stabilizes switch activation, and circulates liquid to minimize stagnation and fluid separation.

The subject matter disclosed and claimed herein, in one embodiment thereof, comprises a dual float liquid level control system. The system is configured to regulate liquid levels within a holding tank through coordinated operation of a first float switch and a second float switch electrically coupled to a control box. The system may comprise an electrical contact circuit configured to remain engaged following activation by the first float switch until deactivation occurs through return of the first float switch to an original position. The first float switch may define a lower activation threshold while the second float switch may define an upper deactivation threshold to establish a controlled liquid level range within the holding tank. The control box may further comprise manual on and off switches, automatic operation switches, indicator lights, transformers, and low-voltage power supplies configured to support multiple operating voltages and system states. The float switches may further comprise cable glands and weighted members configured to maintain stable positioning within the holding tank during operation. One or more contactors may be electrically coupled to pumps, mixers, or circulation devices to manage electrical loads while minimizing contactor vibration and unstable switching conditions. The system may comprise a splash-proof housing having a neoprene seal and mounting structures configured for installation in industrial or commercial environments. Additional configurations may comprise a supplemental control box unit having a supplemental float switch, warning indicators, audio alarms, and timer controls configured to detect fluid loss or pump failure conditions and provide advance warning notifications to users. During operation, the system may permit replenishment or circulation only when liquid levels fall below a predetermined lower threshold and may terminate operation upon reaching a predetermined upper threshold, thereby improving operational consistency and equipment longevity.

In this manner, the dual float liquid level control system of the present invention accomplishes all the foregoing objectives and provides a system configured for precise control of liquid levels within a defined operating range while reducing the excessive cycling commonly associated with single-float systems. More specifically, the coordinated operation of the first float switch and second float switch provides stable activation and deactivation control that minimizes electrical instability, switch bounce, and contactor vibration. The incorporation of circulation or agitation capabilities assists in reducing fluid stagnation, sedimentation, and bacterial growth within holding tanks. The inclusion of warning indicators, supplemental float monitoring, and protective control box features further enhances operational safety and system reliability. Accordingly, the system provides an improved fluid management solution that increases equipment longevity, maintains fluid quality, and improves overall operational performance in a wide variety of liquid control applications.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dual float liquid level control system. The system may provide liquid level control within a holding tank for fluid management applications. The system may utilize a first float switch and a second float switch to maintain a desired liquid level range. Activation of a float cycle by the first float switch may transfer control of an electrical contact circuit to the second float switch. The electrical contact circuit may remain active until the first float switch returns to an original position.

The system may further comprise a control box including the first float switch and the second float switch. The float switches may be configured as normally open or normally closed and may include cable glands and weights for positioning within the holding tank. The system may further comprise manual and automatic on/off switches configured to control operation of the system.

The system may further comprise indicator lights configured to display operating conditions including power status, float cycle activation, pump operation, and unit cycle activity. Additional components may include a transformer, a low-voltage power supply, a splash-proof control box, mounting structures, additional switches, and a contactor configured for electrical switching operations.

During operation, the system may permit liquid replenishment when a liquid level falls below the first float switch and may terminate replenishment when the second float switch detects a full liquid level. The configuration may reduce electrical cycling and improve operational reliability compared to single-float systems.

The system may further comprise a supplemental control box unit configured for use as a loss-of-fluid and equipment failure warning system. The supplemental control box unit may operate as part of a three-float configuration or as a stand-alone unit. The supplemental control box unit may comprise a supplemental float switch positioned within the holding tank and an external warning light indicator configured to provide a visual warning of a failure condition.

In response to a pump failure or loss-of-fluid condition, the supplemental float switch may activate an audio indicator for a selectable duration controlled by a timer. Following expiration of the timed interval, the audio indicator may deactivate while the external warning light indicator continues to provide a visual indication of the failure condition.

Accordingly, the dual float liquid level control system of the present invention is particularly advantageous as it provides a system configured for precise control of liquid levels within a defined operating range while reducing the excessive cycling commonly associated with single-float systems. More specifically, the coordinated operation of the first float switch and second float switch provides stable activation and deactivation control that minimizes electrical instability, switch bounce, and contactor vibration. The incorporation of circulation or agitation capabilities assists in reducing fluid stagnation, sedimentation, and bacterial growth within holding tanks. The inclusion of warning indicators, supplemental float monitoring, and protective control box features further enhances operational safety and system reliability. Accordingly, the system provides an improved fluid management solution that increases equipment longevity, maintains fluid quality, and improves overall operational performance in a wide variety of liquid control applications.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram view of one potential embodiment of a dual float liquid level control system of the present invention in accordance with the disclosed architecture; and

FIG. 2 illustrates a block diagram view of one potential embodiment of a dual float liquid level control system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system that maintains liquid within a precise upper and lower operating range. There also exists a long-felt need in the art for a dual float liquid control system that separates activation and deactivation functions to provide greater operational control than single-float systems. Moreover, there exists a long-felt need in the art for a dual float liquid control system that reduces electrical load, stabilizes switch activation, and circulates liquid to minimize stagnation and fluid separation.

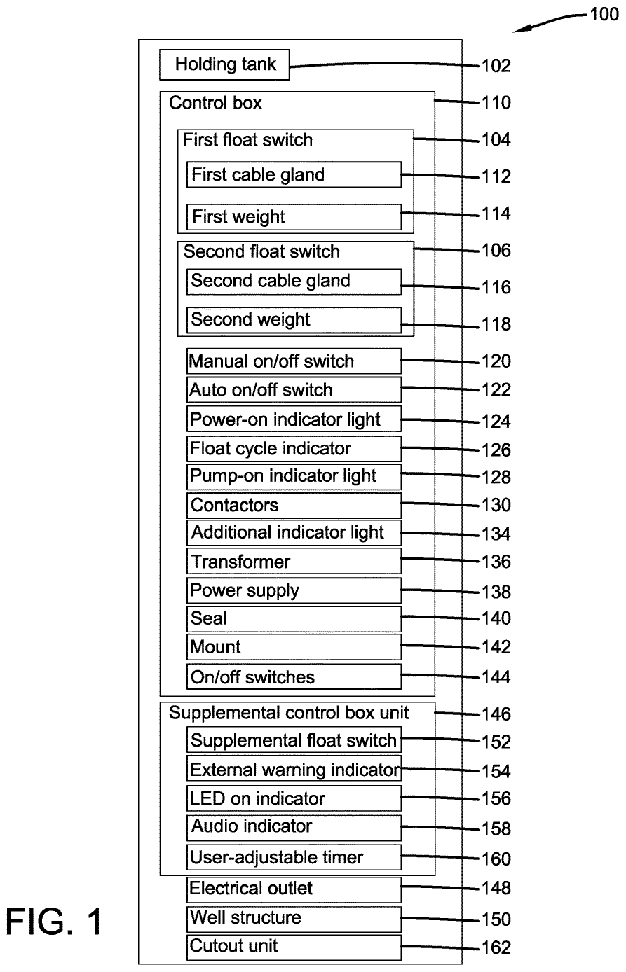

Referring initially to the drawings, FIG. 1 illustrates a block diagram view of one potential embodiment of a dual float liquid level control system 100 of the present invention in accordance with the disclosed architecture. The system 100 may be designed to provide precise control of liquid levels within a holding tank 102 and may be applicable to processes such as but not limited to precision mixing, bottling, and other fluid control operations. The system 100 may operate by using a first float switch 104 and a second float switch 106 in conjunction to establish a desired liquid level range within the holding tank 102. More specifically, when the first float switch 104 engages a float cycle, the second float switch 106 may assume complete control of an electrical contact circuit 108. Once the second float switch 106 makes contact with the electrical contact circuit 108, the electrical contact circuit 108 may become locked in place and may not be deactivated by the second float switch 106. The electrical contact circuit 108 may remain active until the first float switch 104 returns to an original position.

The system 100 may be further comprised of a control box 110 which includes the first float switch 104 and the second float switch 106. The first float switch 104 and the second float switch 106 may be configured as normally open or normally closed depending on whether the application the system 100 is used in involves a sump or the holding tank 102. The first float switch 104 may be equipped with a first cable gland 112 and a first weight 114 to allow stable positioning within the holding tank 102. The second float switch 106 may be equipped with a second cable gland 116 and a second weight 118 to allow stable positioning within the holding tank 102. The system 100 may further include a manual on/off switch 120 configured to allow a user to manually actuate or deactivate the system 100. An auto on/off switch 122 may be present to allow the system 100 to operate in automatic mode or be powered down entirely.

A power-on indicator light 124 may be integrated into the system 100 to visually confirm when the control box 110 is receiving power. A float cycle activated indicator light 126 may indicate when the float cycle has been initiated, and a pump-on indicator light 128 may indicate when one or more contactors 130 have been actuated and a load is active. An additional indicator light 134 may indicate that a unit cycle is active.

Additional components of the system 100 may include a transformer 136 configured to convert voltage for applications ranging from approximately 24 volts to approximately 460 volts. A 24-volt power supply 138 may support low-voltage applications within the control box 110.

The control box 110 may be splash-proof and may include a neoprene seal 140 configured to protect internal components. The system 100 may be mounted in a desired location using a dog ear mount 142. Two additional on/off switches 144 may be included within the system 100. The contactor 130 may be configured to manage electrical switching and may be a two-pole or three-pole design compatible with coil voltages of approximately 24 volts, 110 volts, 230 volts, or 460 volts.

During use, the system 100 may enable liquid replenishment only when a liquid level falls below the position of the first float switch 104 and may ensure that refilling stops once the second float switch 106 detects a full level. This configuration may improve operational reliability, minimize electrical cycling, and reduce contactor vibration. The system 100 may provide more stable activation compared to single-float systems and may enhance the safety and longevity of fluid control equipment.

In an additional configuration, the system 100 may be further comprised of a supplemental control box unit 146 that may be integrated with the system 100 to form a three-float configuration or may be implemented as a stand-alone unit. The supplemental control box unit 146 may operate as a loss-of-fluid and equipment failure warning system such as but not limited to monitoring failure of a well pump. The supplemental control box unit 146 may be powered by connection to a standard 110-volt electrical outlet 148 and may be mounted to a wall adjacent to the holding tank 102 or a well structure 150.

The supplemental control box unit 146 may be comprised of a supplemental float switch 152 positioned within the holding tank 102 and electrically coupled to the supplemental control box unit 146. An external warning light indicator 154 may be mounted outside of the well structure 150 to provide a visual indication of a failure condition and to act as an advance warning prior to the holding tank 102 reaching an empty state. When the supplemental control box unit 146 is energized and operating, the supplemental float switch 152 may be maintained in an upright position and an LED on indicator 156 located on the supplemental control box unit 146 may be illuminated.

In the event of a pump failure or loss of fluid condition, the supplemental float switch 152 may transition to a downward position, thereby triggering an audio indicator 158 or buzzer located on the supplemental control box unit 146. The audio indicator 158 may be configured to operate for a selectable duration such as but not limited to approximately 0.3 seconds to 10 minutes based on a user-adjustable timer 160. Upon completion of the timed interval, the audio indicator 158 may be deactivated along with the LED on indicator 156 located on the supplemental control box unit 146, and a signal may be transmitted to the external warning light indicator 154 mounted outside of the well structure 150, thereby providing a continued visual indication of the failure condition.

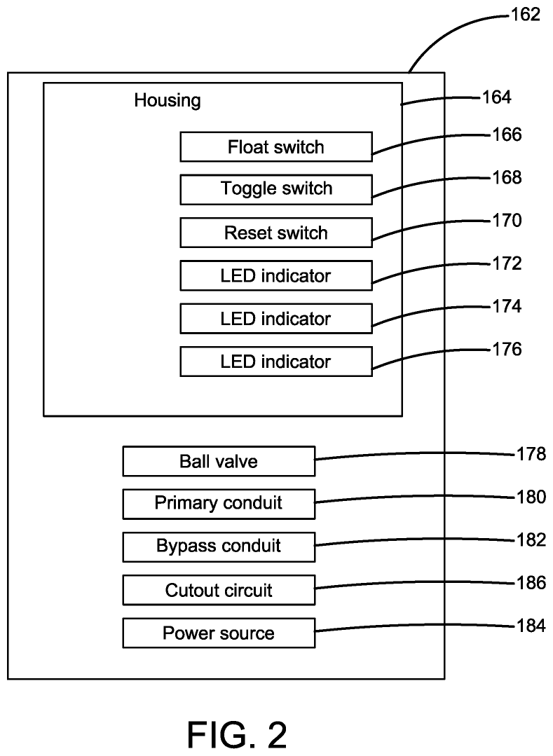

In an additional embodiment as seen in FIG. 2, the system 100 may be further comprised of a fluid bypass and equipment cutout unit 162. The fluid bypass and equipment cutout unit 162 may operate as a stand-alone unit or may be electrically and operationally coupled with the control box 110 and supplemental control box unit 146 to provide coordinated liquid management and equipment protection functions. The fluid bypass and equipment cutout unit 162 may be configured to redirect fluid flow in response to low fluid conditions and may further deactivate associated equipment such as but not limited to commercial booster pumps, reverse osmosis units, circulation pumps, filtration systems, transfer pumps, etc.

The fluid bypass and equipment cutout unit 162 may be comprised of a housing 164 containing a normally closed float switch 166, an on/off toggle switch 168, a momentary reset switch 170, a first LED indicator 172, a second LED indicator 174, and a reset LED indicator 176 integrated with or positioned adjacent to the momentary reset switch 170. The fluid bypass and equipment cutout unit 162 may further be electrically connected to one or more motorized ball valves 178 configured as normally open or normally closed valve assemblies depending on the desired fluid routing application. The motorized ball valves 178 may be positioned within a primary fluid conduit 180 and a bypass conduit 182 to selectively direct fluid flow between a normal flow path and an alternate bypass flow path.

During installation and operation, the fluid bypass and equipment cutout unit 162 may be mounted to a wall, equipment frame, support structure, or adjacent surface near the holding tank 102 or associated processing equipment. The fluid bypass and equipment cutout unit 162 may be connected to a power source 184 and the normally closed float switch 166 may be positioned within the holding tank 102 at a desired monitoring elevation. When the fluid bypass and equipment cutout unit 162 is powered on, the first LED indicator 172 may illuminate to indicate that the fluid bypass and equipment cutout unit 162 is operational and monitoring fluid conditions.

When the normally closed float switch 166 remains in an upward position corresponding to a normal fluid level, fluid may continue through the primary fluid conduit 180 in a standard operational direction. If the fluid level drops below the desired level causing the normally closed float switch 166 to move downward, the motorized ball valves 178 may automatically actuate to redirect fluid through the bypass conduit 182. This bypass operation may isolate or bypass failed equipment and may simultaneously activate an equipment cutout circuit 186 configured to deactivate associated equipment. During the bypass condition, the first LED indicator 172 may deactivate and the second LED indicator 174 may illuminate to visually indicate that the system is operating in a bypass mode.

Following repair, maintenance, or restoration of normal operating conditions, a user may actuate the momentary reset switch 170 to command the motorized ball valves 178 to return fluid flow to the primary fluid conduit 180. Upon reset, the second LED indicator 174 may deactivate and the first LED indicator 172 may re-illuminate to indicate restoration of normal operating conditions. The reset LED indicator 176 associated with the momentary reset switch 170 may remain illuminated during the transition process until the normally closed float switch 166 detects that the fluid level within the holding tank 102 has returned to the desired normal operating level.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dual float liquid level control system” and “system” are interchangeable and refer to the dual float liquid level control system 100 of the present invention.

Notwithstanding the foregoing, the dual float liquid level control system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the dual float liquid level control system 100 as shown in the FIGS. are for illustrative purposes only, and that many other sizes and shapes of the dual float liquid level control system 100 are well within the scope of the present disclosure. Although the dimensions of the dual float liquid level control system 100 are important design parameters for user convenience, the dual float liquid level control system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dual float liquid level control system comprising:
a holding tank;
a first float switch positioned within the holding tank;
a second float switch positioned within the holding tank;
an electrical contact circuit electrically coupled to the first float switch and the second float switch;
a control box electrically coupled to the electrical contact circuit;
wherein the first float switch may initiate a float cycle when a liquid level within the holding tank reaches a first threshold level,
wherein the second float switch may actuate the electrical contact circuit when the liquid level reaches a second threshold level; and
further wherein the electrical contact circuit may remain energized until the first float switch returns to an original position.

2. The dual float liquid level control system of claim 1, wherein the control box further comprises a power-on indicator light configured to visually indicate receipt of electrical power by the control box.

3. The dual float liquid level control system of claim 1, wherein the control box further comprises a float cycle activated indicator light configured to indicate initiation of the float cycle.

4. The dual float liquid level control system of claim 1, wherein the control box further comprises a pump-on indicator light.

5. The dual float liquid level control system of claim 1 further comprising a contactor electrically coupled to the electrical contact circuit.

6. The dual float liquid level control system of claim 5, wherein the contactor is a two-pole contactor or a three-pole contactor.

7. A dual float liquid level control system comprising:
a holding tank;
a first float switch positioned within the holding tank;
a second float switch positioned within the holding tank;
an electrical contact circuit electrically coupled to the first float switch and the second float switch;
a control box electrically coupled to the electrical contact circuit;
wherein the first float switch may initiate a float cycle when a liquid level within the holding tank reaches a first threshold level,
wherein the second float switch may actuate the electrical contact circuit when the liquid level reaches a second threshold level;
wherein the electrical contact circuit may remain energized until the first float switch returns to an original position; and
further wherein the first float switch may initiate a refill cycle when the liquid level within the holding tank falls below a first predetermined level.

8. The dual float liquid level control system of claim 7, wherein the first float switch is suspended within the holding tank by a first cable gland.

9. The dual float liquid level control system of claim 7, further comprising a cutout unit having a third float, a first ball valve, and a second ball valve.

10. The dual float liquid level control system of claim 9, wherein the third float actuates the first ball valve and the second ball valve.

11. The dual float liquid level control system of claim 9, further comprising a plurality of indicators.

12. A dual float liquid level control system comprising:
a holding tank;
a first float switch positioned within the holding tank;
a second float switch positioned within the holding tank;
an electrical contact circuit electrically coupled to the first float switch and the second float switch;
a control box electrically coupled to the electrical contact circuit;
wherein the first float switch may initiate a float cycle when a liquid level within the holding tank reaches a first threshold level,
wherein the second float switch may actuate the electrical contact circuit when the liquid level reaches a second threshold level;
wherein the electrical contact circuit may remain energized until the first float switch returns to an original position;
wherein the first float switch may initiate a refill cycle when the liquid level within the holding tank falls below a first predetermined level; and
further wherein the second float switch may lock the electrical contact circuit into an energized state during filling operations until the first float switch resets following restoration of the liquid level within the holding tank.

13. The dual float liquid level control system of claim 12 further comprising a supplemental control box unit configured to operate as a loss-of-fluid warning system.

14. The dual float liquid level control system of claim 12, wherein the control box further comprises a mounting structure.

15. The dual float liquid level control system of claim 12 further comprising a transformer configured to convert voltage supplied to the control box.

16. The dual float liquid level control system of claim 13 further comprising a supplemental float switch electrically coupled to the supplemental control box unit.

17. The dual float liquid level control system of claim 16, wherein the supplemental float switch is configured to detect a pump failure condition or a low-fluid condition.

18. The dual float liquid level control system of claim 13 further comprising an external warning light indicator electrically coupled to the supplemental control box unit.

19. The dual float liquid level control system of claim 12 further comprising an audio indicator configured to emit an audible warning in response to detection of a failure condition.

20. The dual float liquid level control system of claim 19 further comprising a user-adjustable timer configured to control a duration of operation of the audio indicator.
